(19) United States
(12) Patent Application Publication
(10) Pub. No.: US 2026/0313472 A1
(43) Pub. Date: Oct. 8, 2026

(54) QOE CONTINUITY DURING INTRA-5GC INTER-RAT HANDOVER PROCESS

(71) Applicant: NOKIA TECHNOLOGIES OY, Espoo (FI)

(72) Inventors: Ping YUAN, Beijing (CN); Jing HE, Beijing (CN); Malgorzata TOMALA, Wroclaw (PL)

(21) Appl. No.: 19/480,706

(22) PCT Filed: May 4, 2023
(86) PCT No.: PCT/CN2023/092119

§ 371 Date: Oct. 31, 2025

(51) Int. Cl. H04W 36/00; H04L 41/5067; H04W 36/14; H04W 76/20; H04W 76/30

(52) U.S. Cl. CPC H04W 36/0016; H04L 41/5067; H04W 36/142; H04W 76/20; H04W 76/30

(57) ABSTRACT

Example embodiments of the present disclosure relate to a terminal device, a method, an apparatus and a computer readable storage medium for QoE continuity during an intra-5GC inter-RAT handover process. In some embodiments, a first layer of a terminal device may receive a mobility command from a source network device. The first layer may provide, to an upper second layer of the terminal device, an AT command informing the second layer to release at least one configured QoE measurement and associated RRC ID. As such, the second layer may release the at least one configured QoE measurement and associated RRC ID. Therefore, the QoE continuity may be kept in an inter-RAT handover from NR to LTE, and thus the communication between the terminal device and a target network device may be guaranteed.

### FIELD

Example embodiments of the present disclosure generally relate to the field of telecommunication and in particular, to a terminal device, a method, an apparatus, and a computer readable storage medium for quality of experience (QoE) continuity during an intra-the fifth generation core (intra-5GC) inter-radio access technology (inter-RAT) handover process.

### BACKGROUND

A work item on QoE enhancement is ongoing in the third generation partnership project (3GPP) release 18 (Rel-18). One of the objectives of the work item includes “study the continuity of legacy QoE measurement job for streaming and multimedia telephony service for internet protocol multimedia subsystem (MTSI) service during intra-5GC inter-RAT handover process”.

However, the QoE configurations supported in different RATs are different. Accordingly, how to support the configuration adaptation should be further studied.

### SUMMARY

In general, example embodiments of the present disclosure provide a solution for QoE continuity during an intra-5GC inter-RAT handover process.

In a first aspect, there is provided a terminal device. The terminal device comprises at least one processor and at least one memory storing instructions that, when executed by the at least one processor, cause the terminal device at least to: receive, at a first layer of the terminal device from a first network device, a mobility command; provide, from the first layer of the terminal device to a second layer of the terminal device, an attention (AT) command associated with the mobility command, the AT command informing the second layer to release at least one configured quality of experience (QoE) measurement and associated radio resource control (RRC) identifier (ID), the second layer being an upper layer of the first layer; and release, at the second layer of the terminal device, the at least one configured QoE measurement and associated RRC ID based on the AT command.

In a second aspect, there is provided a method performed by a terminal device. The method comprises: receiving, at a first layer of a terminal device from a first network device, a mobility command; providing, from the first layer of the terminal device to a second layer of the terminal device, an AT command associated with the mobility command, the AT command informing the second layer to release at least one configured QoE measurement and associated RRC ID, the second layer being an upper layer of the first layer; and releasing, at the second layer of the terminal device, the at least one configured QoE measurement and associated RRC ID based on the AT command.

In a third aspect, there is provided an apparatus. The apparatus comprises: means for receiving, at a first layer of a terminal device from a first network device, a mobility command; means for providing, from the first layer of the terminal device to a second layer of the terminal device, an AT command associated with the mobility command, the AT command informing the second layer to release at least one configured QoE measurement and associated RRC ID, the second layer being an upper layer of the first layer; and means for releasing, at the second layer of the terminal device, at least one configured QoE measurement and associated RRC ID based on the AT command.

In a fourth aspect, there is provided a terminal device. The terminal device comprises: receiving circuitry configured to receive, from a first network device, a mobility command; providing circuitry configured to provide, from the first layer of the terminal device to a second layer of the terminal device, an AT command associated with the mobility command, the AT command informing the second layer to release at least one configured QoE measurement and associated RRC ID, the second layer being an upper layer of the first layer; and releasing circuitry configured to release, at the second layer of the terminal device, at least one configured QoE measurement and associated RRC ID based on the AT command.

In a fifth aspect, there is provided a non-transitory computer readable medium comprising program instructions for causing an apparatus to perform at least the method in the second aspect.

In a sixth aspect, there is provided a computer program comprising instructions, which, when executed by an apparatus, cause the apparatus at least to perform the method in the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example process of an example handover from NR to LTE;

FIG. 2 illustrates an example of a network environment in which some example embodiments of the present disclosure may be implemented;

FIG. 3 illustrates an example of a process flow in accordance with some example embodiments of the present disclosure;

FIG. 4 illustrates an example of a process flow of handover from NR to LTE in accordance with some example embodiments of the present disclosure

FIG. 5 illustrates a flowchart of a method implemented at a terminal device in accordance with some example embodiments of the present disclosure;

FIG. 6 illustrates a simplified block diagram of a device that is suitable for implementing some example embodiments of the present disclosure; and

FIG. 7 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Evolved Universal Terrestrial Radio Access Network (E-UTRAN), Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT) and so on. Furthermore, the communications in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the present disclosure, the term “configured QoE measurement” may also be referred to as QoE configuration container, QoE configuration, configured QoE container, or the like, the present disclosure does not limit this aspect.

As mentioned above, the continuity of QoE measurement during intra-5GC inter-RAT handover process is studied. However, the QoE configurations supported in E-UTRAN and NR is different. Hence the configuration adaptation should be supported in order to support QoE measurement continuity for intra-5GC inter-RAT handover.

For example, the configuration of application layer measurements for LTE is specified as:

| | |
|---|---|
| measConfigAppLayer-r15 | CHOICE{ |
| release | NULL, |
| setup | SEQUENCE { |

| | |
|---|---|
| measConfigAppLayerContainer-r15 | OCTET STRING (SIZE(1..1000)), |
| serviceType-r15 | ENUMERATED {qoe, qoemtsi, spare6, |

```
spare5, spare4, spare3, spare2, spare1}
    }
  } OPTIONAL, -- Need ON
```

LTE QoE configuration can support two service types: ‘qoe’ for streaming and ‘qoemtsi’ for MTSI. The filed “measConfigAppLayerContainer” may contain a configuration of application layer measurements, however, the maximum number of configurations of application layer measurements that a UE supports is one regardless of serviceType. In other words, only one QoE configuration can be configured in LTE.

For example, the configuration of application layer measurements for NR is specified as:

| | |
|---|---|
| AppLayerMeasConfig-r17 ::= | SEQUENCE { |

| measConfigAppLayerToAddModList-r17 | SEQUENCE | (SIZE |
|---|---|---|
| (1..maxNrofAppLayerMeas-r17)) OF MeasConfigAppLayer-r17 | OPTIONAL, -- Need N | |
| measConfigAppLayerToReleaseList-r17 | SEQUENCE | (SIZE |
| (1..maxNrofAppLayerMeas-r17)) OF MeasConfigAppLayerId-r17 | OPTIONAL, -- Need N | |
| rrc-SegAllowed-r17 | ENUMERATED | {enabled} |

OPTIONAL, -- Need R
...
}

| | |
|---|---|
| MeasConfigAppLayer-r17 ::= | SEQUENCE { |
| measConfigAppLayerId-r17 | MeasConfigAppLayerId-r17, |
| measConfigAppLayerContainer-r17 | OCTET STRING (SIZE (1..8000)) |

OPTIONAL, -- Need N

| | |
|---|---|
| serviceType-r17 | ENUMERATED {streaming, mtsi, vr, spare5, spare4, |

spare3, spare2, spare1} OPTIONAL, -- Need M

| | |
|---|---|
| pauseReporting-r17 | BOOLEAN |

OPTIONAL, -- Need M

| | |
|---|---|
| transmissionOfSessionStartStop-r17 | BOOLEAN |

OPTIONAL, -- Need M

| | |
|---|---|
| ran-VisibleParameters-r17 | SetupRelease {RAN-VisibleParameters-r17} |

OPTIONAL, -- Cond ServiceType
...
}

NR QoE configuration can support three different service types: ‘streaming’, ‘mtsi’ and ‘vr’, and up to 16 QoE configurations can be configured in NR.

It is agreed that for handover (HO) between LTE/5GC and NR, QoE continuity is done in the access stratum (AS) layer rather than the application layer (AL), which means the QoE measurement continuity in application layer may not be guaranteed. Two principles have been agreed to be further worked out for QoE continuity:
For HO from NR to LTE/5GC, the UE can keep and continue measurements for only one configuration for a service type supported in LTE;
For HO from LTE/5GC to NR, the UE can keep and continue measurements for the ongoing configuration for a service type supported in NR.

The LTE is based on the E-UTRAN RAT, and the NR is based on the NR RAT. In the case of inter-RAT handover from NR to LTE:
The source RAT configures target RAT measurement and reporting.
The source RAT decides on the preparation initiation and provides the necessary information to the target RAT in the format required by the target RAT.
Radio resources are prepared in the target RAT before the handover.
The RRC reconfiguration message from the target RAT is delivered to the source RAT via a transparent container, and is passed to the UE by the source RAT in the handover command.
In-sequence and lossless handovers are not supported.
Security procedures for handover to E-UTRA/EPC should follow E-UTRA handover procedures.

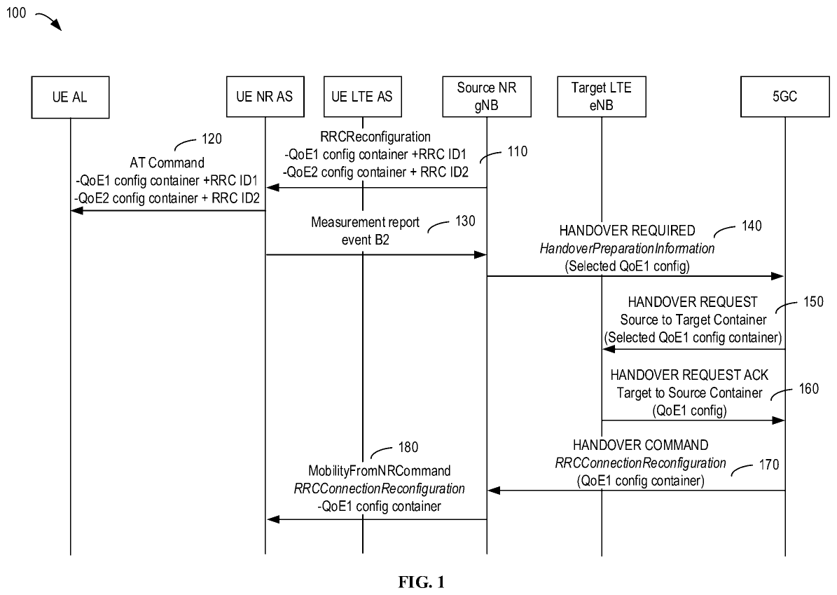

FIG. 1 illustrates an example process 100 of an example handover from NR to LTE. At 110, a source gNB may configure multiple QoE configuration containers and associated RRC IDs. For example, the RRC reconfiguration message may be transmitted from the source gNB to the NR AS layer of the UE, where the RRC reconfiguration message may include: QoE 1 configuration container and its associated RRC ID 1, and QoE 2 configuration container and its associated RRC ID 2.

At 120, each NR QoE configuration container and the associated one short RRC ID (measConfigAppLayerId) may be sent from UE NR AS layer to UE AL together.

For NR QoE reporting, each QoE reporting data together with RRC ID (to identify each NR QoE configuration in UE AS) will be sent back from UE AL to UE AS, for further transmitting to network.

At 130, a measurement report may be transmitted from the UE to the source gNB to trigger the inter-RAT handover.

At 140, the source gNB selects one QoE measurement configured to UE, and sends it to the 5GC by LTE's handover preparation information which includes the selected QoE configuration. For example, the selection of the one QoE measurement is performed up to network implementation.

At 150, the 5GC sends a handover request to the target eNB, and at 160 the target eNB sends a handover request ACK to the 5GC. Accordingly, the selected QoE configuration (selected by the source gNB) can be sent to the target eNB.

At 170, the 5GC sends a handover command to the source gNB, as such LTE's RRC reconfiguration with QoE configuration (selected by the source gNB) from the target eNB may be provided to the source gNB.

At 180, the source gNB sends MobilityFromNRCommand message to the UE with the embedded container including the LTE's RRC connection reconfiguration.

However, LTE QoE doesn't have short RRC ID concept that only one QoE configuration container will be sent to UE AL by UE LTE AS when received from LTE network. Furthermore, the QoE configuration container is common for UE AL whatever received from UE LTE AS or UE NR AS.

The MobilityFromNRCommand message at 180 carries targetRAT-Message Container (LTE RRC connection reconfiguration) including LTE's measConfigAppLayer to UE, where the measConfigAppLayer-r15 is “Need ON”, specified as:

| | | |
|---|---|---|
| [[ | measConfigAppLayer-r15 | CHOICE{ |

| | |
|---|---|
| release | NULL, |
| setup | SEQUENCE{ |

| | |
|---|---|
| measConfigAppLayerContainer-r15 | OCTET STRING (SIZE(1..1000)), |
| serviceType-r15 | ENUMERATED {qoe, qoemtsi, |

spare6, spare5, spare4, spare3, spare2, spare1}

| | |
|---|---|
| | } |
| } | OPTIONAL, -- Need ON |

“Need ON” is used in downlink only, and indicates that the field is optional to signal. If the message is received by the UE, and in case the field is absent, the UE takes no action and where applicable shall continue to use the existing value (and/or the associated functionality).

For the specific scenario of an inter-RAT handover from NR to LTE, there are more than one QoE measurement (e.g., QoE1 and QoE2), running in UE AL before HO.

In case the source gNB selects the QoE1 configuration to target eNB and the target eNB accepts the selection (refer to FIG. 1). The target eNB may use the “Choice-setup” of LTE measConfigAppLayer-r15 to configure the QoE1 configuration to UE by NR MobilityFromNRCommand message. UE LTE AS decodes and forwards the QoE1's measConfigAppLayerContainer to UE AL considering the serviceType. However, NR previously configured QoE2 measurement will be still running in UE AL especially in case relative service is ongoing after handover, resultantly UE AL may send NR's QoE2 reporting data with associated QoE2's RRC ID to UE LTE AS (relative service may be still running in LTE side), which may lead to undefined UE behavior in LTE AS.

In case the source gNB selects the QoE1 configuration to target eNB and the target eNB rejects the selection (e.g., not target eNB's favourity). The target eNB may use the “Choice-release” of LTE measConfigAppLayer-r15 to inform UE AL to clear the stored AL QoE measurement configuration. However, LTE specification has an ambiguity that it is not clear which QoE measurement should be released in UE AL.

In case the source gNB selects the QoE1 configuration to target eNB and the target eNB doesn't support the QoE1 configuration (e.g., doesn't understand the part of configuration). The target eNB may not have measConfigAppLayer-r15 in LTE RRC Connection Reconfiguration container to UE. Based on the definition of “Need ON”, UE LTE AS will do nothing to UE AL. Since there is no informing from UE LTE AS to UE AL, it leads to both QoE1 and QoE2 previously configured by NR will be still running in UE AL especially in case relative service is ongoing after handover.

Therefore, the behavior during a process of inter-RAT handover is needs to be further studied.

Example embodiments of the present disclosure provide a solution for QoE continuity during an intra-5GC inter-RAT handover process. In some embodiments, a first layer of a terminal device may receive a mobility command from a source terminal device. The first layer may provide, to an upper second layer of the terminal device, an AT command informing the second layer to release at least one configured QoE measurement and associated RRC ID. As such, the second layer may release the at least one configured QoE measurement and associated RRC ID. Therefore, the QoE continuity may be kept in an inter-RAT handover from NR to LTE, and thus the communication between the terminal device and a target network device may be guaranteed. Principles and some example embodiments of the present disclosure will be described in detail below with reference to the accompanying drawings.

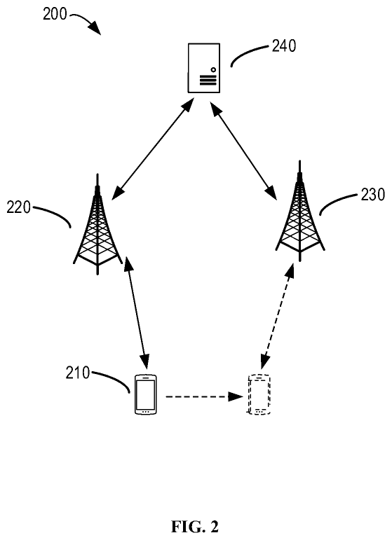

FIG. 2 illustrates an example of a network environment 200 in which some example embodiments of the present disclosure may be implemented. The environment 200, which may be a part of a communication network, comprises a terminal device 210, a first network device 220, a second network device 230, and a core network device 240. The network environment 200 may also be called as a network system, a communication environment, a communication network, a communication system, or the like, the present disclosure does not limit this aspect.

The environment 200 may comprise any suitable number of devices and cells. In the environment 200, the first network device 220 can provide services to the terminal device 210, and the first network device 220 and the terminal device 210 may communicate data and control information with each other. In some embodiments, the first network device 220 and the terminal device 210 may communicate with direct links/channels.

In the environment 200, a link from the first network device 220 to the terminal device 210 is referred to as a downlink (DL), while a link from the terminal device 210 to the first network device 220 is referred to as an uplink (UL). In downlink, the first network device 220 is a transmitting (TX) device (or a transmitter) and the terminal device 210 is a receiving (RX) device (or a receiver). In uplink, the terminal device 210 is a transmitting TX device (or a transmitter) and the first network device 220 is a RX device (or a receiver). It is to be understood that the first network device 220 may provide one or more serving cells. In some embodiments, the first network device 220 can provide multiple cells.

In case a handover occurs, the terminal device 210 may be handed over from the first network device 220 to the second network device 230. In some examples, the handover process may be triggered by a mobility of the terminal device 210, but the present disclosure does not limit this aspect.

The core network device 240 may be implemented as any function in the core network, for ease of description, the core network device 240 may also be referred to as 5GC.

Communications in the network environment 200 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In a specific example, the first network device 220 may be associated with NR or a future RAT, for example, the first network device 220 may be a gNB. In a specific example, the second network device 230 may be associated with LTE or an earlier RAT, for example, the second network device 230 may be an eNB. For ease of description, some of the following embodiments are described with an example of gNB and eNB; however, the embodiments are only for illustration without any limitation, the first network device 220 and the second network device 230 may be in other forms.

It is to be understood that the numbers of devices (i.e., the terminal device 210, the first network device 220 and the second network device 230) and their connection relationships and types shown in FIG. 2 are only for the purpose of illustration without suggesting any limitation. For example, the environment 200 may include any suitable numbers of devices adapted for implementing embodiments of the present disclosure. For example, while FIG. 2 depicts the terminal device 210 as a mobile phone; the terminal device 210 may be any type of user equipment.

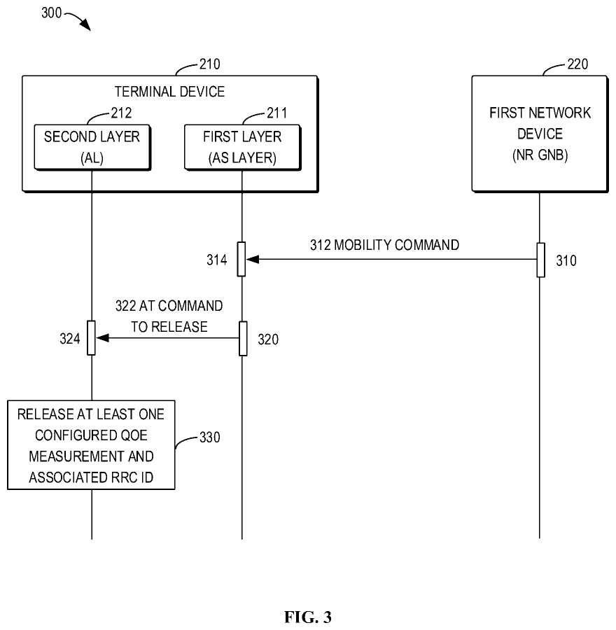

FIG. 3 illustrates an example of a process flow 300 in accordance with some example embodiments of the present disclosure. For the purpose of discussion, the process flow 300 will be described with reference to FIG. 2. The process flow 300 involves the terminal device 210 and the first network device 220. It would be appreciated that although the process flow 300 has been described in the network environment 200 of FIG. 2, this process flow may be likewise applied to other communication scenarios.

As shown in FIG. 3, the terminal device 210 may include a first layer 211 and a second layer 212, where the second layer 212 is an upper layer of the first layer 211. In some examples, the first layer 211 of the terminal device 210 is an access stratum (AS) layer, and the second layer 212 of the terminal device 210 is an application layer (AL). In some other examples, the first layer 211 and the second layer 212 may be implemented as other layers, the present disclosure does not limit this aspect.

In some example embodiments, the first network device 220 may be a network device associated with NR, such as a gNB. In some other example embodiments, the first network device 220 may be associated with a future network, which is not limit in the present disclosure.

The first network device 220 transmits 310 a mobility command 312 to the terminal device 210. On the other side of communication, the terminal device 210 receives 314 the mobility command 312, specifically, the first layer 211 may receive the mobility command 312.

In some examples, the mobility command 312 is transmitted during a handover process, e.g., from the first network device 220 to a second network device 230. For example, the first network device 220 may be referred to as a source network device, and the second network device 230 may be referred to as a target network device. In some example embodiments, the second network device may be a network device associated with LTE, such as an eNB.

In some example embodiments, in case the first network device 220 is associated with NR, such as a gNB, the mobility command 312 may be MobilityFromNRCommand. In some examples, the mobility command 312 may include a QoE configuration container supported by a second network device, i.e., the target network device. In some examples, the mobility command 312 may include RRC connection reconfiguration information associated with the second network device, i.e., the target network device.

The first layer 211 of the terminal device 210 provides 320 an AT command 322 to the second layer 212. Accordingly, the second layer 212 obtains 324 the AT command 322. In some examples, the AT command 322 may be associated with the mobility command 312.

In some examples, the AT command 322 may be used to indicate the second layer 212 to release at least one configured QoE measurement and associated RRC ID. For example, if multiple QoE measurements and associated RRC IDs have been configured, e.g., by the first network device 220, the AT command 322 may indicate the second layer 212 to release the multiple QoE measurements and associated RRC IDs. In some other examples, the AT command 322 may indicate the second layer to release all configured QoE measurements and associated RRC IDs. In some other examples, the AT command 322 may indicate the second layer to release all RRC IDs and configured QoE measurements, besides one QoE measurement, whereas the QoE measurement pertains to one QoE container and/or one service type.

In some examples, each configured QoE measurement may have an associated RRC ID, and different configured QoE measurements may have different RRC IDs. In some examples, the RRC IDs may be used for distinguishing or identifying the multiple QoE measurements, i.e., multiple QoE configuration containers.

The second layer 212 of the terminal device 210 releases 330 the at least one configured QoE measurement and associated RRC ID based on the AT command 322. In some examples, the at least one configured QoE measurement and associated RRC ID may include all QoE measurements and associated RRC IDs configured by the first network device 220. In some examples, the second layer 212 may terminate providing reporting data to the first layer 211. In some other examples, the second layer 212 of the terminal device 210 may release all RRC IDs and configured QoE measurements, besides one QoE measurement, whereas the QoE measurement pertains to one QoE container and/or one service type. In other words, the second layer 212 may maintain one QoE measurement and release all other QoE measurement and all RRC IDs.

The first layer 211 may include a first part associated with the first network device 220 (i.e., source network device) and a second part associated with the second network device (i.e., target network device). In some examples, the first part of the first layer may be represented as NR AS layer, and the second part of the first layer may be represented as LTE AS layer.

In some example embodiments, upon a reception of the mobility command 312, the first part of the first layer may provide the AT command 322 to the second layer. As such, the first part of the first layer (such as NR AS layer) may trigger the release of the QoE configurations in the second layer 212 when it receives the mobility command 312 from the first network device 220. For example, the AT command 322 may be a newly defined attention command, such as a release command.

In some examples, the second layer 212 may stop QoE measurement reporting to the first layer 211, and may release all QoE measurements running in the second layer 212 and associated RRC IDs.

In some examples, the terminal device 210 may further perform an inter-RAT handover process from the first network device 220 to the second network device 230. For example, the terminal device 210 may connect to the second network device 230.

For example, if the handover is successful, the second part of the first layer 211 may further forward QoE configuration container associated with the second network device 230 to the second layer 212, and the second layer 212 may further start a new QoE measurement by following the QoE configuration container associated with the second network device 230. In case there is no QoE configuration container forwarded by the second part of the first layer 211, there will be no QoE measurement running at the second layer of the terminal device 210.

For example, if the handover is failed, the terminal device 210 may return to the first network device 220. It is to be understood that there is no QoE configuration remained in the second layer 212 when the handover is failed.

In some other example embodiments, after successful decoding RRC connection reconfiguration information associated with the second network device 230 or after connecting to the second network device 230, the second part of the first layer may provide the AT command 322 to the second layer. For example, the second part of the first layer (such as LTE AS layer) may trigger the release of the QoE configurations in the second layer 212 when it receives LTE's RRC connection reconfiguration embedded in the mobility command. For example, the second part of the first layer may obtain RRC connection reconfiguration information associated with the second network device 230 by decoding the mobility command 312.

In some examples, the first layer 211 (e.g., including the first part and the second part) may discard QoE reporting data obtained from the second layer 212. In addition or alternatively, the first part of the first layer may inform the second layer to stop QoE measurement and/or QoE reporting, e.g., upon a reception of the mobility command 312. For example, a further newly defined AT command may be used to inform the second layer to stop QoE measurement and/or QoE reporting. In some examples, the second layer 212 may terminate providing the QoE reporting data to the first part of the first layer. In some examples, the at least one QoE measurement and associated RRC ID may be retained in the second layer, until an AT command 322 is obtained.

In some examples, the AT command 322 is provided by the second part of the first layer (e.g., LTE AS) after decoding RRC connection reconfiguration or after a successful RACH access procedure to the second network device 230. In addition or alternatively, the second part of the first layer 211 may further forward QoE configuration container associated with the second network device 230 to the second layer 212.

In some examples, the AT command 322 may be a newly defined attention command, such as a release command. In some other examples, the AT command 322 may be an existing AT command. In some other examples, the AT command 322 may be implicitly indicated by another message. For example, if the handover is successful, the second part of the first layer may provide an existing command which includes a QoE configuration associated with the second network device 230, and the existing command indicates the second layer to release at least one configured QoE measurement and associated RRC ID. As such, no new AT command for releasing is need and the command to release the at least one configured QoE measurement and associated RRC ID may be merged with QoE configuration container associated with the second network device 230, e.g., the second part of the first layer may be aware of that there is QoE configuration container existed in received LTE RRC connection reconfiguration container by “Choice-setup”.

In addition, the second layer 212 may further start a new QoE measurement by following the QoE configuration container associated with the second network device 230. In case there is no QoE configuration container forwarded by the second part of the first layer 211, there will be no QoE measurement running at the second layer of the terminal device 210.

In some other examples, in case the handover is failed, the AT command 322 will not be provided by the second part of the first layer. The terminal device 210 may reconnect to the first network device 220. In some examples, the first part of the first layer may inform the second layer to recover previous stopped QoE measurement or QoE reporting. In other words, if the handover is failed, there is no need for the second part of the first layer to provide the AT command 322 to the second layer, and the at least one configured QoE measurement and associated RRC ID may be further used by the second layer. In some examples, the command used for notifying the second layer to recover the stopped QoE measurement or QoE reporting may be a newly defined recovering command.

In some specific implementations, upon receiving the mobility command 312, the first layer 211 may send a first AT command to the second layer 212, where the first AT command is used for notifying the second layer 212 to stop QoE measurement and stop QoE reporting. In case the handover is successful, the first layer 211 may send a second AT command to the second layer 212 after connecting to the target network device, where the second AT command may notify the second layer 212 to release at least one (such as all) configured QoE measurement and associated RRC ID. The first layer 211 may further send a third AT command to the second layer 212, where the third AT command includes a QoE configuration container associated with the target network device. In some examples, the second AT command and the third AT command may be combined into one AT command, for example, a third AT command may be used to notify the second layer 212 to release at least one configured QoE measurement and associated RRC ID, and the third AT command includes a QoE configuration container associated with the target network device, where there is no second AT command. In case the handover failed, the first layer 211 may send a fourth AT command to the second layer 212, where the fourth AT command may notify the second layer 212 to recover previous stopped (stopping based on the first AT command) QoE measurement and QoE reporting.

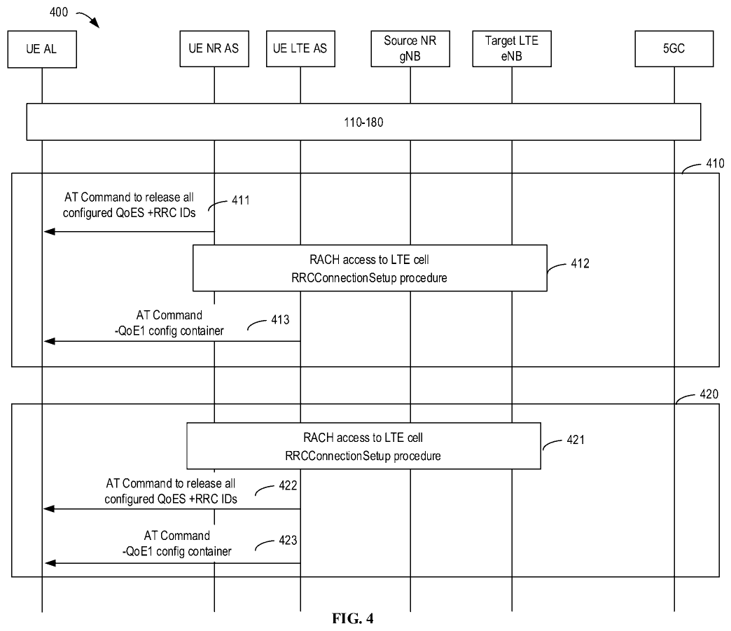

FIG. 4 illustrates an example of a process flow 400 of handover from NR to LTE in accordance with some example embodiments of the present disclosure. The process flow 400 may include the steps 110-180, as shown in FIG. 1, which will not repeat for brevity.

There may be two different solutions for releasing the at least one configured QoE measurement running in the UE AL and associated RRC ID, shown as 410 and 420 respectively.

In option 1, as shown in block 410, the UE NR AS (e.g., upon receiving MobilityFromNRCommand) may provide the AT command to the UE AL, to release all configured QoE measurements and associated RRC IDs at 411. In addition, the UE may perform a RACH procedure, e.g., to RACH access to an LTE cell of the target LTE eNB at 412. At 413, the UE LTE AS may provide another AT command including a QoE configuration container of the target LTE eNB.

The above embodiments of the present disclosure may have partial impact on the current specification. For example, the current specification may be updated (underlined) as follows in view of the above various embodiments of the present disclosure. Regarding reception of the MobilityFromNRCommand by the UE in Clause 5.4.3.3 in TS 38.331, it may be updated as:

| | |
|---|---|
| 5.4.3.3 | Reception of the MobilityFromNRCommand by the UE |

The UE shall:

| 1> | stop timer T310, if running; | |
|---|---|---|
| 1> | stop timer T312, if running; | |
| 1> | if T316 is running: | |
| | 2> | stop timer T316; |
| | 2> | clear the information included in VarRLF-Report, if any; |
| 1> | if T390 is running: | |
| | 2> | stop timer T390 for all access categories; |
| | 2> | perform the actions as specified in 5.3.14.4; |
| 1> | if the targetRAT-Type is set to eutra: | |
| | 2> | consider inter-RAT mobility as initiated towards E-UTRA; |
| | 2> | forward the nas-SecurityParamFromNR to the upper layers, if included; |
| | 2> | if the UE is configured to send application layer measurement report for any |
| | | measConfigAppLayerId: |

3> inform upper layers about the release of all the application layer measurement

| | | configuration including any RAN visible application layer measurement configuration; |
|---|---|---|
| 1> | else if the targetRAT-Type is set to utra-fdd: | |
| | 2> | consider inter-RAT mobility as initiated towards UTRA-FDD; |
| | 2> | forward the nas-SecurityParamFromNR to the upper layers, if included; |

| | |
|---|---|
| 1> | access the target cell indicated in the inter-RAT message in accordance with the |
| | specifications of the target RAT. |

In option 1, as shown in block 420, after receiving MobilityFromNRCommand, UE may perform a RACH procedure, e.g., to RACH access to an LTE cell of the target LTE eNB at 421. After receiving the LTE RRC connection reconfiguration message, the UE LTE AS may provide the AT command to the UE AL, to release all configured QoE measurements and associated RRC IDs at 422. At 423, the UE LTE AS may provide another AT command including a QoE configuration container of the target LTE eNB. In some examples, the steps 422 and 423 may be combined into one step, i.e., one AT command.

The above embodiments of the present disclosure may have partial impact on the current specification. For example, the current specification may be updated (underlined) as follows in view of the above various embodiments of the present disclosure. Regarding reception of the RRCConnectionReconfiguration by the UE in Clause 5.4.2.3 in TS 36.331, it may be updated as:

| | |
|---|---|
| 5.4.2 | Handover to E-UTRA |
| 5.4.2.3 | Reception of the RRCConnectionReconfiguration by the UE |

If the UE is able to comply with the configuration included in the RRCConnectionReconfiguration
message, the UE shall:

| 1> | inform upper layers about the release of all the application layer measurement configuration. | |
|---|---|---|
| 1> | if the RRCConnectionReconfiguration message includes the otherConfig: | |
| | 2> | perform the other configuration procedure as specified in 5.3.10.9; |

Regarding other configuration in Clause 5.3.10.9 in TS 36.331, it may be updated as:

| | |
|---|---|
| 5.3.10.9 | Other configuration |

The UE shall:

| 1> | if the received otherConfig includes the measConfigAppLayer: | |
|---|---|---|
| | 2> | if measConfigAppLayer is set to setup: |

| | |
|---|---|
| 3> | if the configuration is sent via other RAT |
| 4> | inform upper layers about the release of all the application layer measurement |
| | configuration, if any. |

| | |
|---|---|
| 3> | forward measConfigAppLayerContainer to upper layers considering the serviceType; |
| 3> | consider itself to be configured to send application layer measurement report in accordance |
| | with 5.6.19; |

| | |
|---|---|
| 2> | else: |

| | |
|---|---|
| 3> | inform upper layers to clear the stored application layer measurement configuration; |
| 3> | discard received application layer measurement report information from upper layers; |
| 3> | consider itself not to be configured to send application layer measurement report. |

It is to be understood that the AT command at 411 or 422 is used to release all QoE configuration containers and associated RRC IDs; however, this is only for illustration without any limitation, for example, the AT command at 411 may be used to release part of all QoE configuration containers and associated RRC IDs, e.g., only one QoE configuration container and associated RRC ID will be released, the present disclosure does not limit this aspect.

It is to be understood that the process flow 400 includes operations 110-180, where a QoE configuration container selected by the source gNB is accepted by the target eNB; however in some other cases, the target eNB may reject or may ignore the QoE configuration container selected by the source gNB, the present disclosure does not limit this aspect.

According to some embodiments described above, the QoE continuity may be kept in an inter-RAT handover from NR to LTE, remove the ambiguity in current procedure may be removed by defining clear new UE behavior(s).

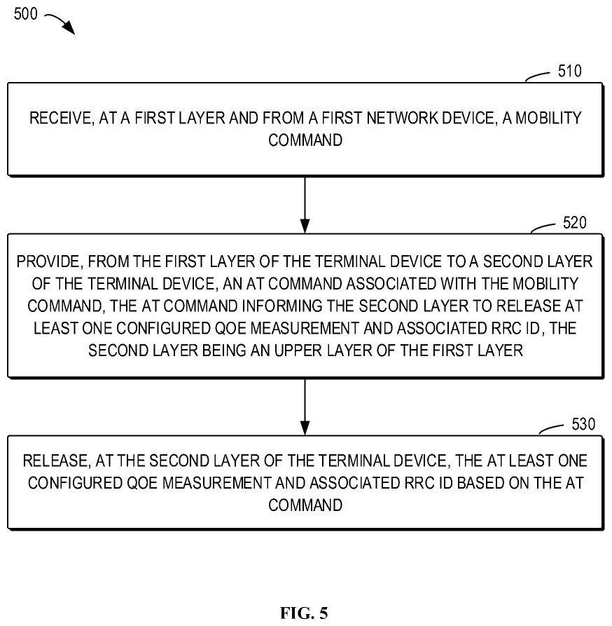

FIG. 5 illustrates a flowchart of a method 500 implemented at a terminal device in accordance with some example embodiments of the present disclosure. For the purpose of discussion, the method 500 will be described from the perspective of the terminal device 210 with reference to FIG. 2.

At block 510, a first layer of the terminal device 210 receives, from a first network device, a mobility command. At 520, the first layer of the terminal device provides, to a second layer of the terminal device, an AT command associated with the mobility command, where the AT command informs the second layer to release at least one configured QoE measurement and associated RRC ID, and where the second layer is an upper layer of the first layer. At 530, the second layer of the terminal device releases the at least one configured QoE measurement and associated RRC ID based on the AT command.

In some example embodiments, a first part of the first layer of the terminal device provides, to the second layer of the terminal device, the AT command upon a reception of the mobility command, wherein the first part of the first layer is associated with the first network device.

In some example embodiments, a second part of the first layer of the terminal device provides, to the second layer of the terminal device, the AT command after successful decoding RRC connection reconfiguration information associated with a second network device or after connecting to the second network device, wherein the second part of the first layer is associated with the second network device.

In some example embodiments, the first layer of the terminal device discards QoE reporting data obtained from the second layer.

In some example embodiments, a first part of the first layer of the terminal device informs, to the second layer of the terminal device, upon a reception of the mobility command, to stop at least one of: QoE measurement or QoE reporting.

In some example embodiments, the AT command comprises a QoE configuration container configured by the second network device.

In some example embodiments, the terminal device, such as the second part of the first layer of the terminal device, obtains RRC connection reconfiguration information associated with the second network device by decoding the mobility command.

In some example embodiments, the second network device is a long term evolution (LTE) network device. In some example embodiments, the first network device is a new radio (NR) network device.

In some example embodiments, the terminal device performs an inter-radio access technology (RAT) handover process from the first network device to the second network device.

In some example embodiments, the at least one configured QoE measurement and associated RRC ID comprise all configured QoE measurements and associated RRC IDs configured by the first network device.

In some example embodiments, the first layer of the terminal device is an access stratum (AS) layer, and the second layer of the terminal device is an application layer.

In some example embodiments, an apparatus capable of performing the method 500 (for example, the terminal device 210) may comprise means for performing the respective steps of the method 500. The means may be implemented in any suitable form. For example, the means may be implemented in a circuitry or software module.

In some example embodiments, the apparatus comprises: means for receiving, at a first layer of the terminal device from a first network device, a mobility command; means for providing, from the first layer of the terminal device to a second layer of the terminal device, an attention (AT) command associated with the mobility command, the AT command informing the second layer to release at least one configured quality of experience (QoE) measurement and associated radio resource control (RRC) identifier (ID), the second layer being an upper layer of the first layer; and means for releasing, at the second layer of the terminal device, the at least one configured QoE measurement and associated RRC ID based on the AT command.

In some example embodiments, the apparatus comprises: means for providing, from a first part of the first layer to the second layer, the AT command upon a reception of the mobility command, wherein the first part of the first layer is associated with the first network device.

In some example embodiments, the apparatus comprises: means for providing, from a second part of the first layer to the second layer, the AT command after successful decoding RRC connection reconfiguration information associated with a second network device or after connecting to the second network device, wherein the second part of the first layer is associated with the second network device.

In some example embodiments, the apparatus comprises: means for discarding, at the first layer of the terminal device, QoE reporting data obtained from the second layer.

In some example embodiments, the apparatus comprises: means for informing, from a first part of the first layer to the second layer upon a reception of the mobility command, to stop at least one of: QoE measurement or QoE reporting.

In some example embodiments, the AT command comprises a QoE configuration container configured by the second network device.

In some example embodiments, the apparatus comprises: means for obtaining RRC connection reconfiguration information associated with the second network device by decoding the mobility command.

In some example embodiments, the second network device is an LTE network device, such as an eNB. In some example embodiments, the first network device is an NR network device, such as a gNB.

In some example embodiments, the apparatus comprises: means for performing an inter-RAT handover process from the first network device to the second network device.

In some example embodiments, the at least one configured QoE measurement and associated RRC ID comprise all configured QoE measurements and associated RRC IDs configured by the first network device.

In some example embodiments, the first layer of the terminal device is an access stratum (AS) layer, and the second layer of the terminal device is an application layer.

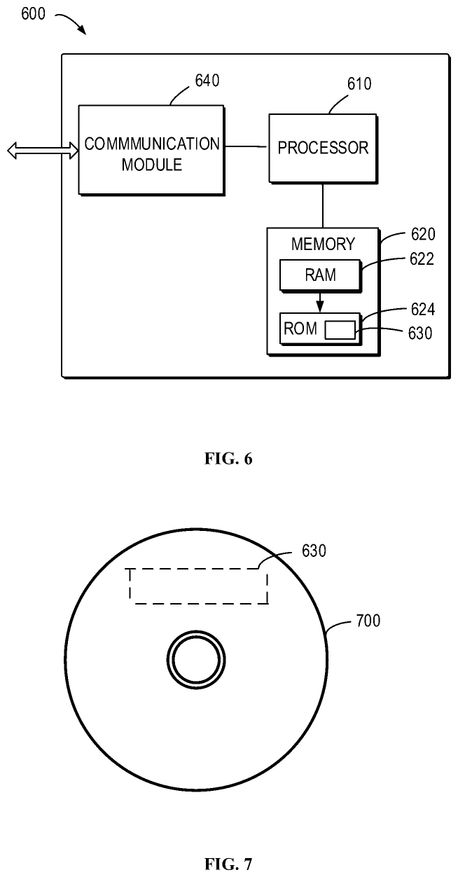

FIG. 6 illustrates a simplified block diagram of a device 600 that is suitable for implementing some example embodiments of the present disclosure. The device 600 may be provided to implement the communication device, for example the terminal device 210 as shown in FIG. 2. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 3-5. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like.

FIG. 7 illustrates a block diagram of an example of a computer readable medium 700 in accordance with some example embodiments of the present disclosure. The computer readable medium 700 has the program 630 stored thereon. It is noted that although the computer readable medium 700 is depicted in form of CD or DVD in FIG. 7, the computer readable medium 700 may be in any other form suitable for carry or hold the program 630.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, at a first layer of the terminal device from a first network device, a mobility command;
provide, from the first layer of the terminal device to a second layer of the terminal device, an attention (AT) command associated with the mobility command, the AT command informing the second layer to release at least one configured quality of experience (QoE) measurement and associated radio resource control (RRC) identifier (ID), the second layer being an upper layer of the first layer; and
release, at the second layer of the terminal device, the at least one configured QoE measurement and associated RRC ID based on the AT command.

2. The terminal device of claim 1, wherein the terminal device is caused to:
provide, from a first part of the first layer to the second layer, the AT command upon a reception of the mobility command, wherein the first part of the first layer is associated with the first network device.

3. The terminal device of claim 1, wherein the terminal device is caused to:
provide, from a second part of the first layer to the second layer, the AT command after successful decoding RRC connection reconfiguration information associated with a second network device or after connecting to the second network device, wherein the second part of the first layer is associated with the second network device.

4. The terminal device of claim 3, wherein the terminal device further caused to:
discard, at the first layer of the terminal device, QoE reporting data obtained from the second layer.

5. The terminal device of claim 3, wherein the terminal device further caused to:
inform, from a first part of the first layer to the second layer upon a reception of the mobility command, to stop at least one of: QoE measurement or QoE reporting.

6. The terminal device of claim 3, wherein the AT command comprises a QoE configuration container configured by the second network device.

7. The terminal device of claim 3, wherein the terminal device further caused to:
obtain RRC connection reconfiguration information associated with the second network device by decoding the mobility command.

8. The terminal device of claim 3, wherein the second network device is a long term evolution (LTE) network device.

9. The terminal device of claim 3, wherein the first network device is a new radio (NR) network device.

10. The terminal device of claim 2, wherein the terminal device further caused to:
perform an inter-radio access technology (RAT) handover process from the first network device to the second network device.

11. The terminal device of claim 1, wherein the at least one configured QoE measurement and associated RRC ID comprise all configured QoE measurements and associated RRC IDs configured by the first network device.

12. The terminal device of claim 1, wherein the first layer of the terminal device is an access stratum (AS) layer, and the second layer of the terminal device is an application layer.

13. A method comprising:
receiving, at a first layer of a terminal device from a first network device, a mobility command;
providing, from the first layer of the terminal device to a second layer of the terminal device, an attention (AT) command associated with the mobility command, the AT command informing the second layer to release at least one configured quality of experience (QoE) measurement and associated radio resource control (RRC) identifier (ID), the second layer being an upper layer of the first layer; and
releasing, at the second layer of the terminal device, at least one configured QoE measurement and associated RRC ID based on the AT command.

14. (canceled)

15. A computer readable storage medium that is non-transitory comprises program instructions for causing a terminal device at least to:
receive, at a first layer of the terminal device from a first network device, a mobility command;
provide, from the first layer of the terminal device to a second layer of the terminal device, an attention (AT) command associated with the mobility command, the AT command informing the second layer to release at least one configured quality of experience (QoE) measurement and associated radio resource control (RRC) identifier (ID), the second layer being an upper layer of the first layer; and
release, at the second layer of the terminal device, the at least one configured QoE measurement and associated RRC ID based on the AT command.

16. The method of claim 13, wherein the providing comprises providing, from a first part of the first layer to the second layer, the AT command upon a reception of the mobility command, wherein the first part of the first layer is associated with the first network device.

17. The method of claim 16, wherein the method further comprises performing an inter-radio access technology (RAT) handover process from the first network device to the second network device.

18. The method of claim 13, wherein the providing comprises providing, from a second part of the first layer to the second layer, the AT command after successful decoding RRC connection reconfiguration information associated with a second network device or after connecting to the second network device, wherein the second part of the first layer is associated with the second network device.

19. The method of claim 18, wherein the method further comprises discarding, at the first layer of the terminal device, QoE reporting data obtained from the second layer.

20. The method of claim 18, wherein the method further comprises informing, from a first part of the first layer to the second layer upon a reception of the mobility command, to stop at least one of: QoE measurement or QoE reporting.

21. The method of claim 18, wherein the method further comprises obtaining RRC connection reconfiguration information associated with the second network device by decoding the mobility command.
